(19) United States
(12) Patent Application Publication
(10) Pub. No.: US 2004/0173654 A1
(43) Pub. Date: Sep. 9, 2004

(54) Cantilevered heavy duty hitch dolly

(76) Inventor: William McAlister, Smithtown, NY (US)

Correspondence Address: ALFRED M. WALKER, 225 OLD COUNTRY ROAD, MELVILLE, NY, 11747-2712, US

(21) Appl. No.: 10/791,327

(22) Filed: Mar. 2, 2004

Related U.S. Application Data
(60) Provisional application No. 60/451,915, filed on Mar. 4, 2003.

(51) Int. Cl. B60D 1/00

(52) U.S. Cl. 224/519; 280/495

(57) ABSTRACT

A cantilevered hitch dolly is used with and in combination with a vehicle trailer hitch extending from the vehicle to support a storage container thereon. The dolly includes a platform having a hitch receiver member. A connector removably connects the hitch receiver member to an exposed end of the trailer hitch to provide cantilever support of the platform above ground level, so that when the platform is connected to the trailer hitch, the vehicle may be moved with the dolly firmly joined to the vehicle and free of any contact with the ground level. A plurality of swiveled legs are mounted on opposite sides of the platform, and are lowered when the vehicle is in place and the dolly is being removed from attachment to the vehicle. Wheels are mounted on bottom ends of the swiveled legs to allow the dolly to be readily moved about after detachment from the vehicle and being wheeled back into position for attaching the hitch receiver member to the trailer hitch.

### RELATED APPLICATIONS

This application is based upon provisional patent application serial No. 60/451,915, filed Mar. 4, 2003, and claims benefit under 35 U.S.C. 119(e).

### FIELD OF THE INVENTION

The present invention relates to a convertible motor vehicle hitch attached platform which converts to a dolly for items being transported.

### BACKGROUND OF THE INVENTION

Platforms for carrying heavy objects such as industrial tool boxes or containers for fishing and camping equipment exist. Typically a horizontal frame includes a receiver rod member which is insertable into the hollow end of a motor vehicle hitch attached to the vehicle.

Because the hitches are cumbersome and heavy, they are difficult to maneuver and manipulate, especially when installing one to the motor vehicle hitch. They often weigh in excess of 100 pounds, and have to be carefully placed within the hitch receiver, which is partially hidden under the vehicle and low to the ground.

When removed from the vehicle, the support platforms transporting an industrial tool box or container for camping and fishing equipment are useless, and the boxes or containers having been transported must stay stationary on the ground or floor.

However, in industrial field environments, or at recreational sites, it would be desirable to move the box or container around.

### OBJECTS OF THE INVENTION

It is therefore an object of the present invention to provide a support platform for heavy duty industrial work boxes or recreational containers, wherein the support platform converts to a wheeled dolly for moving the heavy duty box or container around.

It is also an object of the present invention to provide a dolly for an easily installable support platform which attaches to a motor vehicle hitch.

Other objects which become apparent from the following description of the present invention.

### SUMMARY OF THE INVENTION

In keeping with these objects and others which may become apparent, the present invention is a heavy duty dolly including a support platform cantilevered to the front or rear of a motor vehicle which is fitted with a class 3 or class 4 trailer hitch.

The platform has a recessed edge within a frame to accommodate a large box which is then easily transported. The box may be an industrial tool box, or it may serve recreational uses. A fishing supply box with integral fillet cutting board may be fitted for example. A large food and beverage cooler for beach or football tailgate parties can also be accommodated.

The support platform is fitted with a plurality of swivel mount jacks with casters, such as four swivel mount jacks. These are swung into a generally horizontal planar alignment with the platform and locked into this position for transport when attached in cantilever fashion to a vehicle.

When the motor vehicle has arrived at its destination, the cantilevered heavy duty hitch dolly can be conveniently detached by swinging the four swivel mounted jacks ninety degrees with the casters pointing vertically downward toward the ground. Then the crank handles are rotated on each of the four jacks to elongate their shaft so as to contact the ground and relieve the load on the coupling shank which is attached to the trailer hitch. At this point, the hitch pin is removed from the trailer hitch and the platform has been converted into a dolly that can be easily rolled on the four casters at the distal ends of the jacks.

The swivel mount jacks and casters are just as useful for the coupling task when the dolly height is simply adjusted to cantilever height to match the level of the trailer hitch. After coupling, the four jacks are adjusted to minimal height and rotated ninety degrees into horizontal alignment with the plane of the platform.

With ruggedized construction and heavy duty shock-mounted jacks installed, the hitch dolly of this invention can also be used for military or rescue missions to deliver a box of supplies for rapid attachment to a motor vehicle. Both cable deployment from a helicopter as well as parachute drops from fixed wing aircraft are feasible.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a side elevational view of the hitch dolly of this invention, shown cantilevered to the rear of a motor vehicle;

FIG. 2 is a side elevational view of the hitch dolly of this invention, shown cantilevered to the front of a motor vehicle;

FIG. 3 is a side detailed view of the hitch dolly cantilevered to a vehicle;

FIG. 4 is a rear view of the hitch dolly and transported box cantilevered to a vehicle, wherein undercarriage parts of the vehicle are shown in dashed lines;

FIG. 5 is a perspective view of the hitch dolly of this invention, shown detached from the vehicle and resting on casters of swivelable mounting jacks, shown deployed vertically on the ground;

FIG. 6 is a perspective view of a box positioned atop the hitch dolly, which is shown detached from the vehicle and resting on casters;

FIG. 7 is a perspective view of a helicopter delivering a supply box attached to the hitch dolly of the present invention, shown being delivered to a waiting emergency vehicle; and,

FIG. 8 is a perspective view of a parachute drop delivering supply boxes for quick attachment to waiting ground vehicles.

### DETAILED DESCRIPTION OF THE INVENTION

The present invention has broad applications to many technical fields for a variety of articles. For illustrative purposes only, a preferred mode for carrying out the invention is described herein.

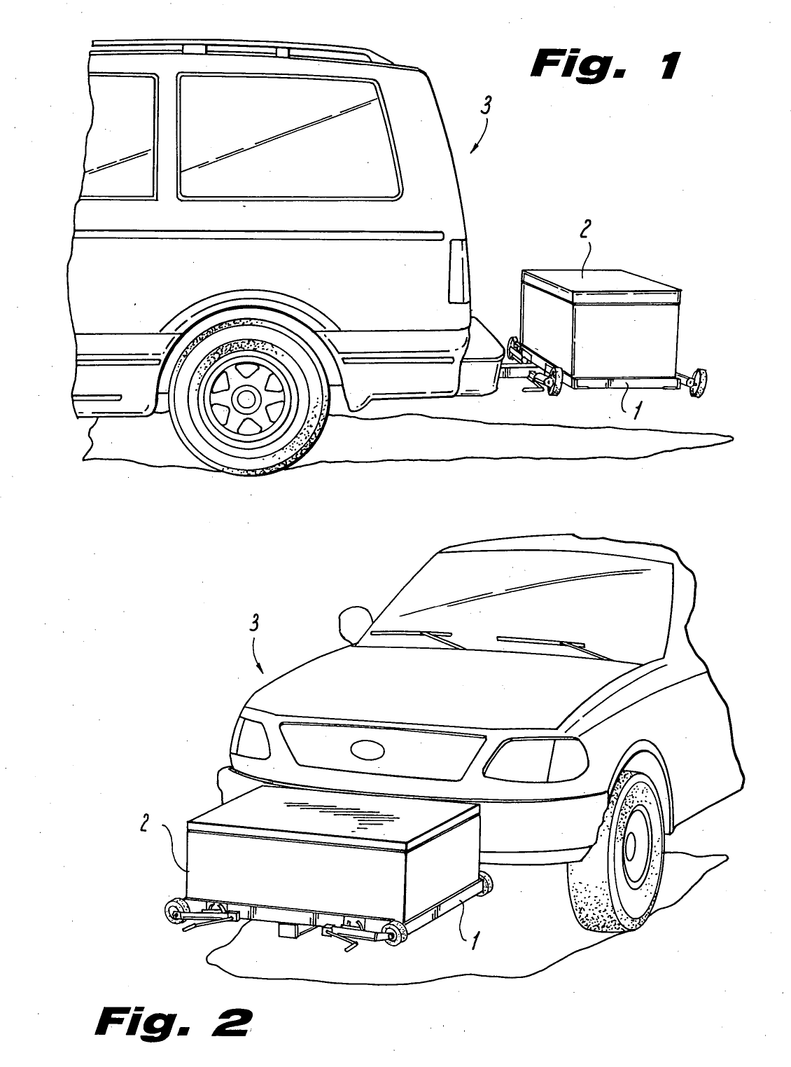

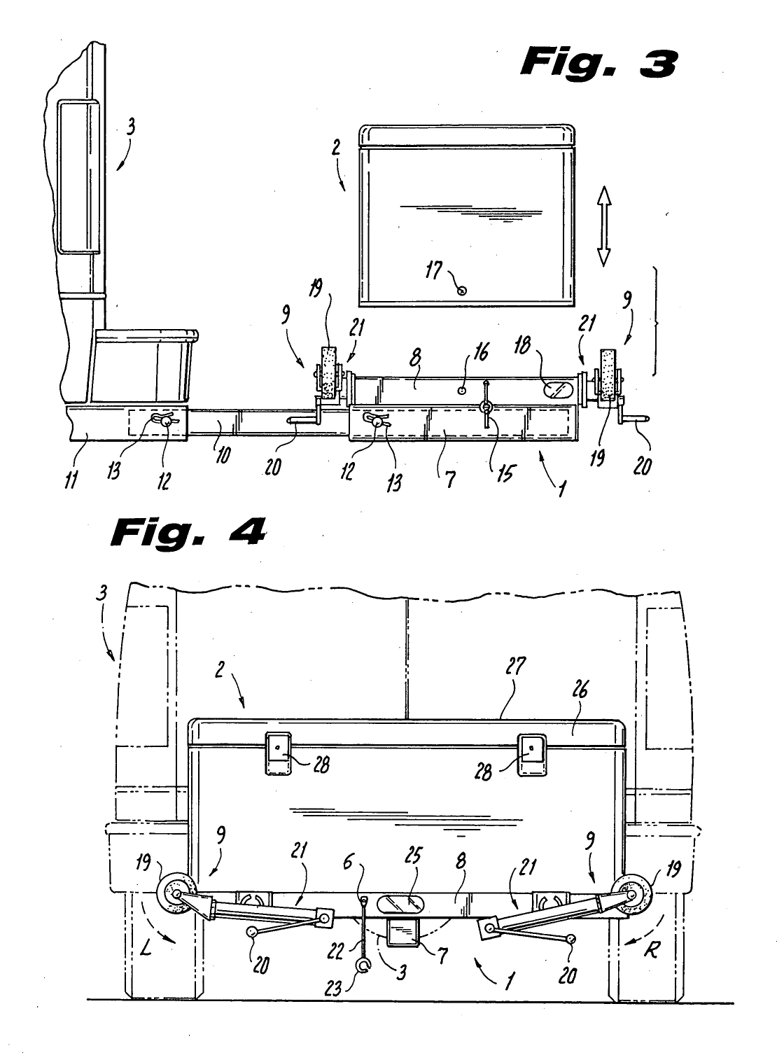

FIGS. 1 and 2 shown hitch dolly 1 in various positions of use. For example, cantilevered hitch dolly 1 of this invention is shown attached to the rear of vehicle 3 in FIG. 1. Box 2 is carried by hitch dolly 1. In FIG. 2, hitch dolly 1 is cantilevered from the front of vehicle 3.

FIG. 3 shows a side view of hitch dolly 1 cantilevered from trailer hitch 11 which is attached to the vehicle frame. A class 3 or class 4 trailer hitch 11 is frame attached in a secure fashion, so as to be able to withstand considerable moment and force loading. For example, these trailer hitches are rated from 3500 to 12,000 pounds of gross towing weight (GTW) and from 350 to 1200 pounds tongue weight (TW).

Trailer hitch 11 includes a hollow receiver interior recess which accepts a coupler, such as, for example, a typically two inch square coupling shank 10, for coupling. A fastener, such as hitch pin 12 with retaining clip 13, is used to lock in coupling shank 10 to trailer hitch 11. The same arrangement or alternate methods are used to attach coupling shank 10 to hollow hitch receiver member 7 of hitch dolly 1. When not in use (e.g.—decoupled) shank coupling 10 can be stored within hollow hitch receiver member 7. Receiver member 7 is fastened, by welding or other means, to the bottom of frame 8 of hitch dolly 1.

By also viewing the rear view of FIG. 4, hitch dolly 1 with box 2 can be visualized more clearly. Safety cable 22, attached to loop 6 on a frame member of frame 8, preferably has a hitch fastener, such as a “C”-shaped loop at its distal end, for attachment to an attachment member, such as loop 5, of trailer hitch 11.

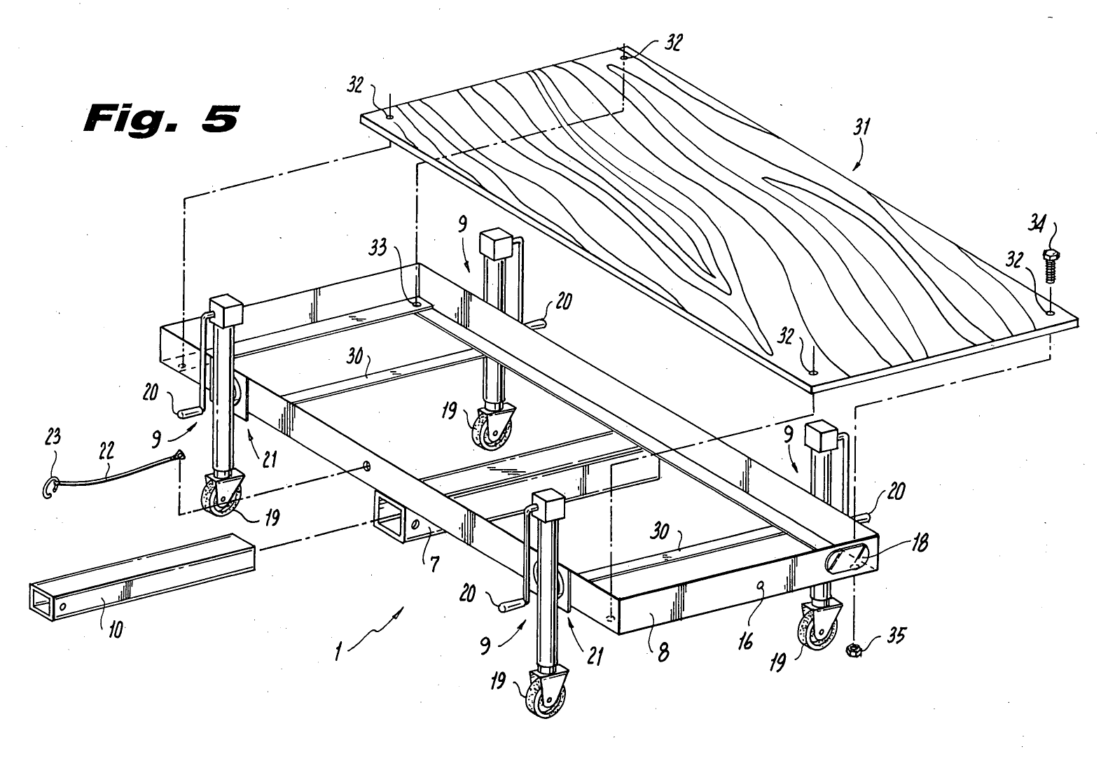

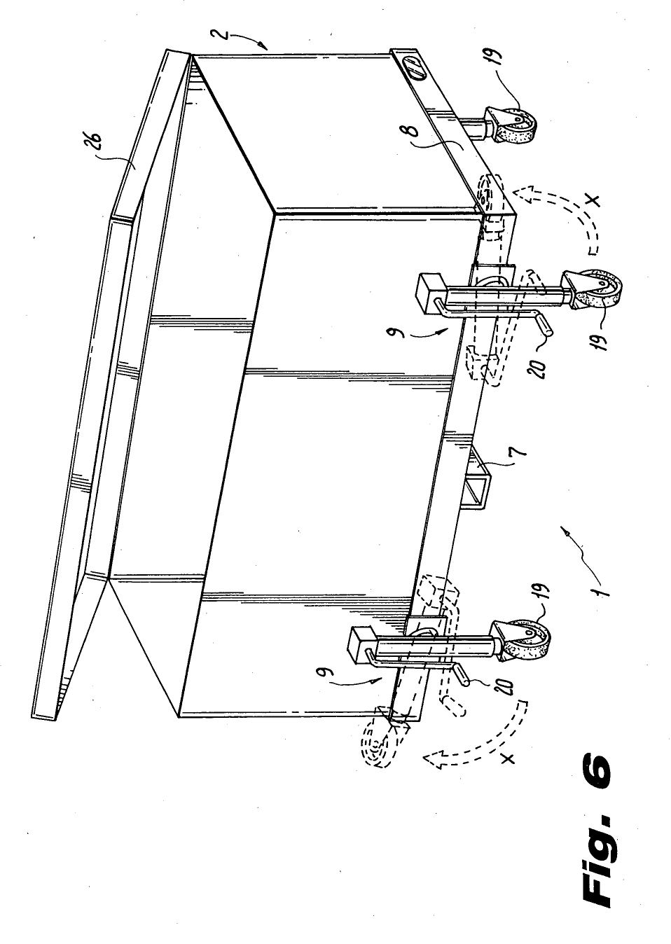

Furthermore, the frame construction is clearly shown in FIG. 5, which shows hitch dolly 1 detached from vehicle 3 and resting on movement actuators, such as wheels, bearings or casters 19. As also shown in FIG. 5, mount jacks 9, preferably four in number, are attached to the long frame 8 members of hitch dolly 1 via a mount, such as swivel mounts 21. Swivel mount jacks 9 are operated for elongation or shortening by starters, such as crank handles 20, and can be locked in either the horizontal storage position shown in FIGS. 3 and 4, or rotated 90 degrees as shown by directions “L” and “R” in FIG. 4, to end up in the upright vertical position shown in FIG. 5. A model 2614 Fulton swivel mount tongue jack as shown in the Draw-Tite catalog from Cequent Towing Products, (Goshen, Ind.), can be utilized as a typical swivel mount jack 9.

Preferably, reflectors 18 and 25 or other sources of illumination, such as lights (not shown) are attached to the sides and rear of frames of hitch dolly 1, respectively to enhance night visibility. Box 2 is restrained from lifting from frame 8 due to dynamic forces such as hitting a pothole. One method (as in FIG. 3) is the use of spring pins 15 inserted through frame holes 16 and further into box holes 17 which are in registration with holes 16. Other methods include ropes, straps, or bungee cords which are draped over box 2 and attached to frame 8.

In FIG. 4, box 2 is illustrated as a fishing supply box with lid 26, hasps 28 and integral fillet top 27. For another application, a tool storage chest such as the model 2060 from the KNAACK® catalog can be used. In addition, other containers, such as cooler chests or other like shaped containers can be accommodated by hitch dolly 1.

The structure of hitch dolly 1 is evident from FIG. 5. It is preferably fabricated from welded angle members for frame 8 with optional flat cross members 30. Hollow receiver member 7 is welded to the bottom of the long members of frame 8 at the center. Either steel or aluminum construction of appropriate gauge for the required strength can be used. Furthermore, frame 8 forms a resting edge for box 2. Alternatively, optional full floor panel 31 can be attached to frame 8. Plywood is illustrated in FIG. 5, but other panel materials such as flake board, honeycomb composite or other synthetic materials can be used. Four holes 32 are shown for attachment. They are positioned adjacent to the corners of panel 31 and are in positional registration with holes 33 in frame 8. A fastener, such as bolt 34 and nut 35, are used with each hole 32 to attach panel 31 to frame 8. Additional bolts with accomodating holes can be used to make the attachment more rigid.

FIG. 6 shows that, when detached, box 2 can be conveniently wheeled around on movement actuators, such as casters 19. Swivel mount jacks 9 can be adjusted for convenient height. For example, the height can be adjusted so that lid 26 can be used as a table top. Of course, swivel mount jacks 9 are adjusted to match the height of hitch 11 when attaching or detaching to a vehicle.

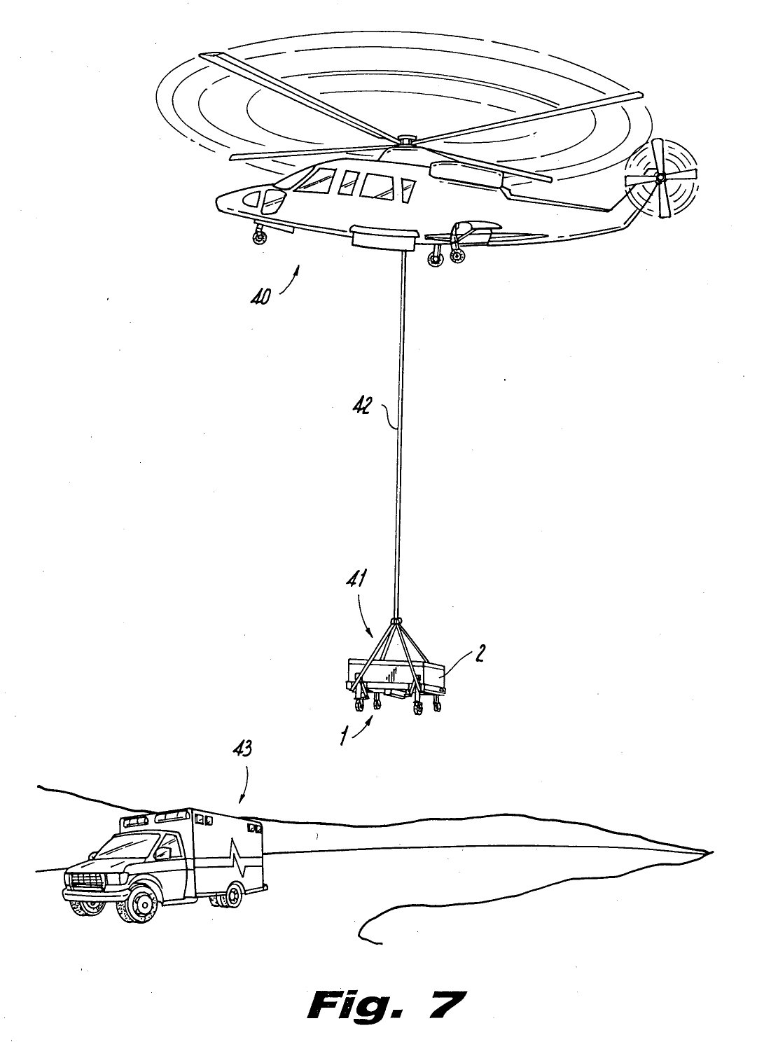

FIG. 7 illustrates delivery of emergency supplies by helicopter 40 via a tether, such as winched line 42 with harness 41 attached to hitch dolly 1. Supplies are in box 2 which is attached to hitch dolly 1. Swivel mount jacks 9 are deployed in the “wheels down” position during this maneuver. Since frame 8 and swivel mount jacks 9 must withstand greater shock loads in this application, ruggedized jacks with impact resistant casters 19 (such as polyurethane), shock mounted swivel mounts 21, and more robust frame members should be used. In this illustration, hitch dolly is rapidly rolled over to waiting emergency vehicle 43 and attached in cantilever fashion to its trailer hitch 11.

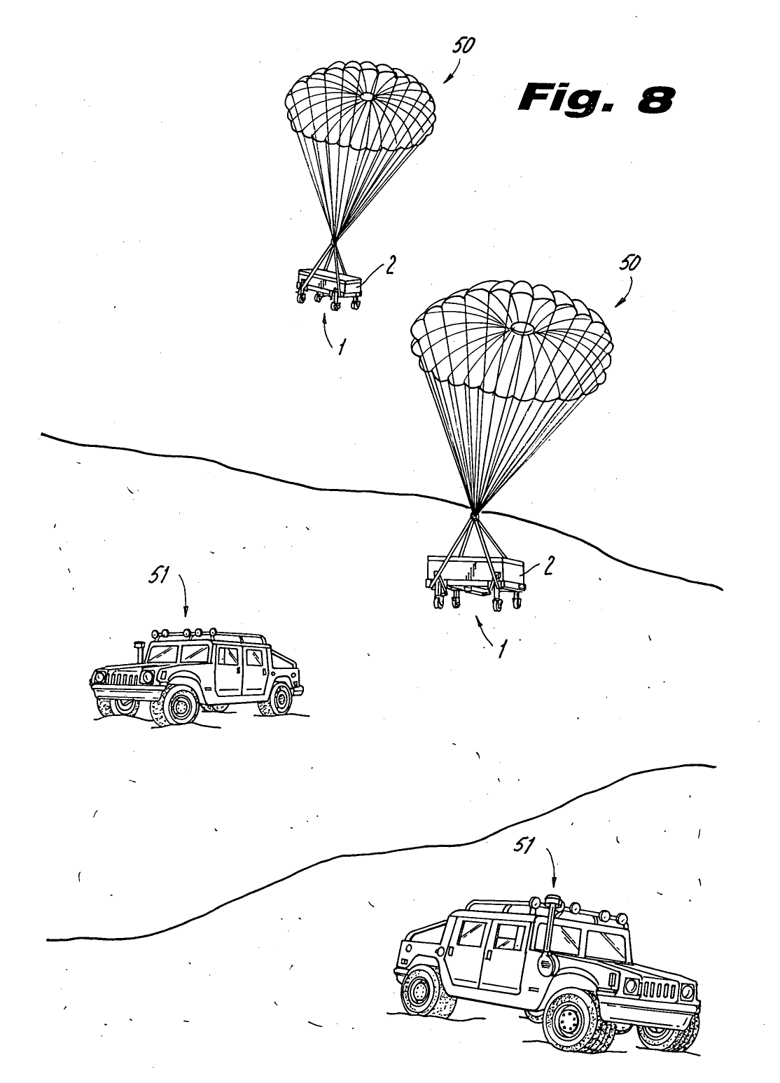

In similar fashion, heavy duty hitch dollies can be air dropped via parachute. Such an arrangement is shown in FIG. 8 in a military air drop. Parachutes 50 are used to air drop boxes 2 attached to dollies 1 of this invention. In the scenario depicted, an open area is used for the air drop of supplies such as medial equipment or ammunition. Waiting vehicles are then used to transport dollies 1 cantilevered to their rear trailer hitch to a final destination (such as a city center or mountainous region) which may be inaccessible to direct air drops.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is also noted that the foregoing examples are exemplary only, and the present invention is not limited thereby.

It is further known that other modifications may be made to the present invention, without departing the scope of the invention, as noted in the appended claims.

I claim:

1. A cantilevered hitch dolly for use with and in combination with a vehicle comprising:
a trailer hitch extending from said vehicle;
a dolly comprising a platform having a hitch receiver member;
a connector removably connecting said hitch receiver member to an exposed end of said trailer hitch for providing cantilever support of said platform above ground level so that when said platform is connected to said trailer hitch said vehicle may be moved with said dolly firmly joined to said vehicle and free of any contact with the ground level; and
a plurality of swiveled legs mounted on opposite sides of said platform for being lowered when said vehicle is in place and said dolly is being removed from attachment to said vehicle; and,
respective movement actuators being mounted on bottom ends of said swiveled legs to allow said dolly to be readily moved about after detachment from said vehicle and being wheeled back into position for attaching said hitch receiver member to said trailer hitch.

2. The cantilevered hitch dolly of claim 1 in which said means for removably connecting said hitch receiver member to said trailer hitch comprises a coupling shank removably attachable at one end to said trailer hitch and another end to said hitch receiver member.

3. The cantilevered hitch dolly of claim 2 in which said hitch receiver member is adapted to receive and store said coupling shank when not in use.

4. The cantilevered hitch dolly of claim 3 in which each of said swiveled legs comprises a jack mounted on a side of said platform for rotation about a swivel joint, said jack being elongated and stored parallel to a side of said platform when retracted, one end of said jack having a wheel mounted thereon and an opposite end of said jack having a crank handle for allowing the lowering of said wheel when said jack is pivoted into a vertical position for relieving the load on said trailer hitch and thereby permitting convenient release of said dolly from said vehicle.

5. The cantilevered hitch dolly of claim 4 in which said platform is fabricated from angle members for supporting a storage container.

6. The cantilevered hitch dolly of claim 5 in which said hitch receiver member is attached to an underside of said platform.

7. The cantilevered hitch dolly of claim 6 in which said storage container is an industrial toolbox.

8. The cantilevered hitch dolly of claim 6 in which said storage container is a recreational storage box.

9. The cantilevered hitch dolly of claim 6 further comprising a workspace mountable over said storage container.

10. The cantilevered hitch dolly of claim 6 in which said storage container and said hitch dolly are attached to an airlift drop.

11. The cantilevered hitch dolly of claim 1 wherein said movement actuators are casters.

12. The cantilevered hitch dolly of claim 1 wherein said movement actuators are wheels.
